(19) United States
(12) Patent Application Publication
(10) Pub. No.: US 2026/0184361 A1
(43) Pub. Date: Jul. 2, 2026

(54) WHEEL INSERTION ELEMENT

(71) Applicant: Adam Hall GmbH, Neu-Anspach (DE)

(72) Inventors: Silvan ERNST, Neu-Anspach (DE); Arsen STJEPANOVIC, Düsseldorf (DE)

(21) Appl. No.: 19/436,457

(22) Filed: Dec. 30, 2025

(30) Foreign Application Priority Data
Dec. 31, 2024 (DE) 202024107651.6

(51) Int. Cl. B62B 5/00

(52) U.S. Cl. CPC B62B 5/0093

(57) ABSTRACT

A wheel insertion element adapted for moving a component base plate, the wheel insertion element including a frame body, at least one wheel rotatably mounted on the frame body, wherein the frame body includes an upper part and a lower part, wherein at least one stop element is arranged between the upper part and the lower part, wherein the frame body is adapted to receive a component base plate in that the component base plate can be inserted along an insertion direction between the upper part and the lower part and can be placed against the at least one stop element, and wherein a guide element is attached to the upper part and/or to the lower part, which protrudes from the frame body against the insertion direction and is adapted to guide the component base plate into the frame body.

### BACKGROUND

The invention relates to a wheel insertion element.

Components with a base plate are known from the prior art. For example, stands with a base plate are known, so that the stand ensures a secure stand. Truss base plates are also known, which can hold stage structures, for example.

All these base plates are naturally relatively heavy and relatively large, in order to enable a reliable stand on a floor. However, this also leads to the fact that the components with a base plate or the base plate alone is difficult to handle, in particular is difficult to transport. This makes it complicated, for example, to convey such base plates to the intended place on a stage or during an event. This is usually done manually in that the base plate is carried to the desired installation site. If the base plate is to be displaced in the mounted state, dismounting must usually take place, in order to be able to displace the base plate. For example, a stand must be dismounted before its base plate can be displaced.

### SUMMARY

It is the object of the invention to provide a wheel insertion element which, with simple and cost-effective production and mounting, allows secure and reliable transport of component base plates.

This object is achieved by the features of the present application. The present application contains preferred developments of the invention.

The wheel insertion element is adapted for moving a component base plate. For example, stands can be moved effortlessly and securely with the aid of the wheel insertion element, without having to dismount the stands. The wheel insertion element can be simply plugged onto the base plate of the stand, and the stand can be tilted onto the wheel insertion element and then moved. For example, a component base plate can also be moved solely by means of the wheel insertion element. In particular, stand base plates usually have a handle or a handle recess, by means of which the stand base plate can be moved on the wheel insertion element.

The wheel insertion element has a frame body and at least one wheel rotatably mounted on the frame body. Preferably, two wheels rotatably mounted on the frame body are provided. If a plurality of wheels are present, they have in particular the same axis of rotation.

The frame body has an upper part and a lower part. At least one stop element is arranged between the upper part and the lower part. Preferably, the upper part and the lower part do not touch. In particular, the upper part and the lower part are fixedly connected to one another via mounting elements such as screws or rivets or the like. The at least one stop element preferably serves as a spacer for the upper part and the lower part.

The frame body is adapted to receive a component base plate in that the component base plate can be inserted along an insertion direction between the upper part and the lower part and can be placed against the at least one stop element. Thus, the component base plate together with the frame body can be tilted onto the wheel mounted on the frame body in order to be able to displace the component base plate. Preferably, the axis of rotation of the at least one wheel is transverse, preferably perpendicular, to the insertion direction.

A guide element is attached to each of the upper part and/or the lower part. The guide element protrudes from the frame body against the insertion direction and is adapted to guide the component base plate into the frame body. In particular, the guide element is thus arranged on the frame body in the form of a cantilever beam. The guide element is in particular adapted to come into contact with the component base plate as a first component of the wheel insertion element when the wheel insertion element is plugged onto the component base plate. This allows guidance of the component base plate between the upper part and the lower part of the frame body.

Preferably, the stop elements comprise column-shaped stop elements and at least one wall-shaped stop element. The column-shaped stop elements and the wall-shaped stop element each extend between the upper part and the lower part. In particular, forces can thereby be introduced into the upper part and the lower part. The column-shaped stop elements advantageously serve to produce punctiform contact with the component base plate, wherein the at least one wall-shaped stop element is advantageously provided for producing a planar contact with the stop element.

Particularly advantageously, the column-shaped stop elements are sleeve-shaped and surround a screw element. The screw element is attached for screwing the upper part and the lower part, wherein the column-shaped stop elements are in particular formed as spacers between the upper part and the lower part. The column-shaped stop element thus preferably fulfills a plurality of functions. On the one hand, the screw element is protected by the stop element, and on the other hand, the component base plate is protected from the screw element by the sleeve-shaped stop element when the stop is reached. Moreover, the sleeve-shaped stop element is preferably formed as a spacer, so that a predefined distance between the upper part and the lower part is maintained when connecting the upper part and the lower part by means of the screw element. The screw element is for example screwed into a thread of the upper part or lower part of the frame body.

Moreover, the at least one wall-shaped stop element is particularly preferably attached to the upper part and/or the lower part. In particular, the wall-shaped stop element is attached by material bonding, preferably glued. The stop element is thus held on the frame body in a simple and reliable manner.

Two guide elements are preferably attached to each of the upper part and the lower part. A guide element attached to the upper part and a guide element attached to the lower part are formed opposite each other in order to guide the component base plate therebetween. The risk of tilting of the component base plate is thus minimized. In addition, the component base plate can be reliably guided.

Particularly preferably, two wheels are rotatably mounted on the frame body. All guide elements are attached in particular to a region of the frame body between the wheels. The wheels are preferably arranged on the same axis of rotation. The wheel insertion element is thus stable and easy to handle.

Each wheel is preferably mounted on a region of the frame body between two stop elements, in particular column-shaped stop elements. In this case, in particular one stop element, in particular a column-shaped stop element, is arranged between the wheel and the guide elements. A particularly stable construction is thus achieved.

The guide element advantageously comprises an attachment region and a support region along the insertion direction. The guide element abuts the frame body in particular at the attachment region and is attached thereto. For example, the guide element is plugged onto the frame body, in particular the upper part or lower part, with the attachment region and/or screwed to the frame body, in particular the upper part or lower part. Furthermore, it is preferably provided that the guide element protrudes from the frame body at the support region. If the component base plate is to be plugged together with the wheel insertion element, the component base plate always first comes into contact with the respective support region of the at least one guide element.

The frame body is formed to rest on a ground on the at least one wheel and on at least one guide element attached to the lower part. A contact of the lower part with the ground is preferably avoided. The guide element is preferably formed from a friction-optimized material or comprises a friction-optimized coating. The wheel insertion element can thus be moved over a floor in a simple and cost-effective manner. A damage or wear of the frame body is thereby minimized. A possibly worn guide element can be dismounted and replaced in a simple and cost-effective manner.

The frame body advantageously comprises an engagement element. The engagement element is designed for holding and/or guiding the wheel insertion element by a user. In particular, the engagement element is designed for actuation by a foot of the user. The engagement element extends along a direction which, starting from the upper part, comprises a component in the direction of the lower part or, starting from the lower part, comprises a component in the direction of the upper part. Particularly advantageously, the engagement element is formed in one piece with the upper part and/or the lower part. A user is thus enabled in a simple and cost-effective manner to move the wheel insertion element over a floor and in particular to apply it to a component base plate. Handling of the wheel insertion element is thus simplified.

The stop element is preferably made of plastic or a rubber material, in particular of a hard rubber material. Rubber material is to be understood here as meaning in particular a material based on natural rubber or synthetic rubber. Alternatively or additionally, the guide element is preferably made of plastic or a rubber material, in particular hard rubber material. This serves on the one hand to protect the component base plate from damage, and on the other hand, the stop element and/or the guide element are formed robustly in this manner in order to guide and/or limit a movement of the component base plate during the insertion.

It is preferably provided that the upper part and/or the lower part are made of a metallic material. For example, the upper part and/or the lower part are made of steel or of aluminum. As a result, the upper part and/or the lower part are formed stable and robust and at the same time light.

The stop elements, in particular the column-shaped stop elements, are preferably arranged offset with respect to the insertion direction. This allows optimum accommodation of component base plates of different sizes and/or a certain lateral guidance of the component base plate transversely to the insertion direction.

### BRIEF DESCRIPTION OF THE DRAWINGS

Further details, advantages and features of the present invention emerge from the following description of exemplary embodiments with reference to the drawing. In the drawing:

FIG. 1 shows a schematic perspective illustration of a wheel insertion element according to an exemplary embodiment of the invention,

FIG. 2 shows a schematic plan view of the wheel insertion element according to the exemplary embodiment of the invention, and

FIG. 3 shows a schematic side view of the wheel insertion element according to the exemplary embodiment of the invention.

### DETAILED DESCRIPTION

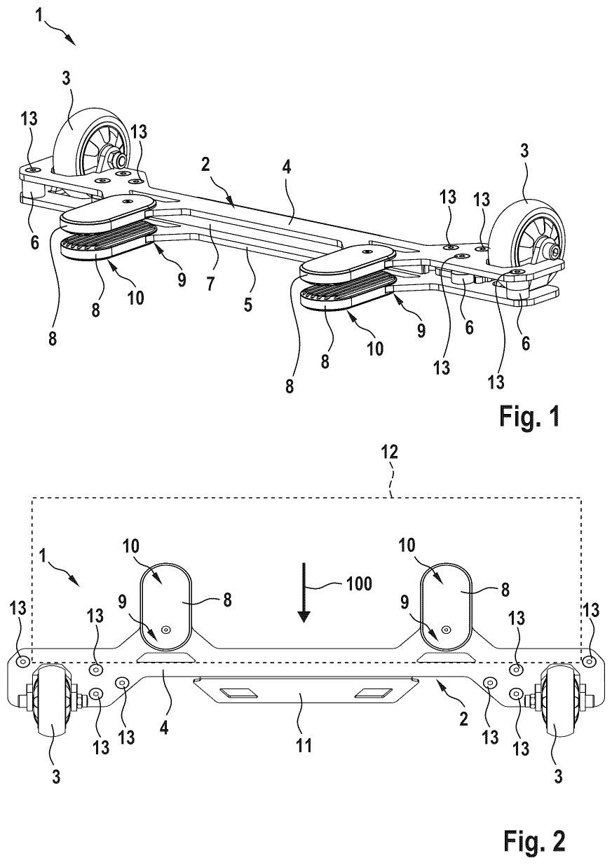

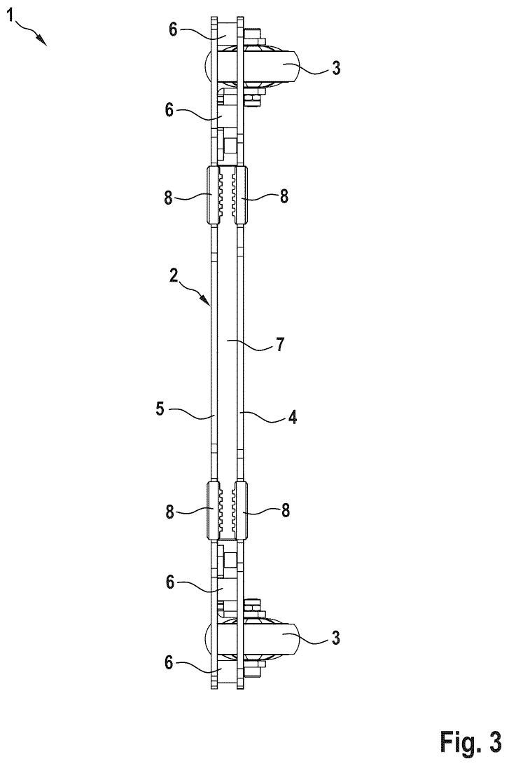

FIGS. 1 to 3 show different schematic illustrations of a wheel insertion element 1 according to an exemplary embodiment of the invention and are described jointly below. The wheel insertion element 1 is adapted for moving a component base plate 12. For this purpose, the wheel insertion element 1 is adapted to receive the component base plate 12 in that it is inserted into the wheel insertion element 1 along an insertion direction 100.

The wheel insertion element 1 comprises a frame body 2 and at least one wheel 3 rotatably mounted on the frame body 2, wherein in the exemplary embodiment shown, two wheels 3 are each attached to an outer region of the frame body 2 transversely to the insertion direction 100. The two wheels 3 are rotatably mounted about the same axis of rotation.

The frame body 2 comprises an upper part 4 and a lower part 5. The upper part 4 and/or the lower part 5 are made of a metallic material, for example. An advantageous material is steel, for example. Aluminum would also be possible. As a result, the upper part 4 and the lower part 5 are formed stable and robust and also light. This leads to optimum properties of the frame body 2.

In this exemplary embodiment, a plurality of stop elements 6, 7 are arranged between the upper part 4 and the lower part 5. In this exemplary embodiment, the plurality of stop elements 6, 7 are a plurality of column-shaped stop elements 6 and a wall-shaped stop element 7, which all each extend between the upper part 4 and the lower part 5.

The column-shaped stop elements 6 are, for example, sleeve-shaped and serve in particular a plurality of purposes. It is thus preferably provided that the sleeve-shaped column-shaped stop elements 6 each surround a screw element 13. Each screw element 13 is attached for screwing the upper part 4 and the lower part 5. For example, the screw elements 13 are guided through the upper part 4 and screwed to the lower part 5, for example by a thread being formed on the lower part 5. The column-shaped stop elements 6 are furthermore preferably formed as spacers between the upper part 4 and the lower part 5. The upper part 4 and the lower part 5 can thus be screwed to one another in a simple manner, wherein a predefined distance remains between the upper part 4 and the lower part 5.

The frame body 2 is adapted to receive a component base plate 12 in that the component base plate 12 can be inserted along the insertion direction 100 into the distance between the upper part 4 and the lower part 5. The stop elements 6, 7 serve as a stop for the component base plate 12, so that the component base plate 12 can be placed against the stop elements 6, 7. The column-shaped stop elements 6 surround the screw elements 13 in a sleeve-shaped manner and thus serve on the one hand to protect the screw elements 13 from the component base plate 12 and on the other hand to protect the component base plate 12 from the screw elements 13. The wall-shaped stop element 7 serves to abut the component base plate 12 in a planar manner and is attached to the upper part 4 and/or the lower part 5. Attachment takes place by material bonding, for example.

The stop elements 6, 7 are, for example, made of plastic, for example of PA6. Alternatively, the stop elements 6, 7 can also be made of a rubber material, in particular hard rubber material.

Two guide elements 8 are attached to each of the upper part 4 and the lower part 5. Each guide element 8 protrudes from the frame body 2 against the insertion direction 100. Each guide element 8 comprises an attachment region 9 and a support region 10 along the insertion direction 100. It is provided that the respective guide element 8 abuts the frame body 2 and is attached thereto at the attachment region 9. For example, the guide element 8 is plugged onto the upper part 4 or the lower part 5 with the attachment region 9 and is fixed by screwing to the upper part 4 or the lower part 5. The respective guide element 8 also protrudes from the frame body 2 at the support region 10.

A guide element 8 attached to the upper part 4 and a guide element attached to the lower part 5 are formed opposite each other in order to guide the component base plate 12 therebetween. The guide elements 8 are adapted to guide the component base plate 12 into the frame body 2. It is achieved by the respective support regions 10 that the component base plate 12 touches the guide elements 8 as first components of the wheel insertion element 1. Reliable guidance of the component base plate by the guide elements 8 is thus provided. In particular, it is provided that the component base plate 12 touches only the guide elements 8 and the stop elements 6, 7, but not the frame body 2.

Each guide element 8 is made of a rubber material, in particular hard rubber material, for example. As a result, the respective guide element 8 is formed in particular robust and stable, wherein the guide elements 8 can assume a reliable guidance function of the base plate 12. Alternatively, the guide elements 8 can also be made of plastic.

The frame body 2 is formed such that it rests on a ground on the two wheels 3 and on the two guide elements 8 attached to the lower part 5. In particular, a contact of the frame body 2 itself, above all a contact of the lower part 5 with the ground, is thereby avoided. The risk of damage or wear of the frame body 2 by grinding on the ground is thus minimized. Moreover, the regions of the guide elements 8 resting on the ground are preferably formed or coated in a friction-optimized manner, so that simple handling of the wheel insertion element 1 is enabled.

For simple handling of the wheel insertion element 1, the frame body 2 comprises an engagement element 11. The engagement element 11 is formed for holding and/or guiding the wheel insertion element 1 by a foot of a user. It is provided that the engagement element 11 is formed in one piece with the upper part 5 and extends along a direction which, starting from the upper part 4, comprises a component in the direction of the lower part 5. The engagement element 11 thus extends obliquely downwards, starting from the upper part 4.

A user can thus guide the wheel insertion element 1 along the ground without the latter having to bend. Operation with only the foot is enabled in a simple and advantageous manner. The wheel insertion element 1 can thus be simply pushed onto a component base plate 1. If the component base plate is, for example, a stand base plate, the stand does not have to be dismantled. The stand can possibly be easily tilted in order to insert the component base plate 12 into the wheel insertion element 1. The component base plate 12 together with the wheel insertion element 1 can then be tilted onto the wheels 3 and moved in a simple and reliable manner.

Ideally, all guide elements 8 are attached to a region of the frame body 2 between the wheels 3. Likewise, the wall-shaped stop element 7 is preferably arranged between the wheels 3, ideally in the region of the guide elements 8. Each wheel 3 is advantageously mounted on a region of the frame body 2 between two column-shaped stop elements 6. In addition, one column-shaped stop element 6 is preferably arranged in each case between the wheel 3 and the guide elements 8. This leads to a particularly stable construction of the wheel insertion element 1. In addition, the component base plate 12 can thereby be accommodated in an optimum manner in order to move it safely and reliably. The column-shaped stop elements 6 can also be arranged offset with respect to the insertion direction 100, in order to enable optimum accommodation of component base plates 12 of different sizes.

In addition to the above written description of the invention, reference is hereby explicitly made to the graphical illustration of the invention in the figures for the supplementary disclosure thereof.

### REFERENCE NUMERAL LIST

1 wheel insertion element
2 frame body
3 wheel
4 upper part of the frame body
5 lower part of the frame body
6 column-shaped stop element
7 wall-shaped stop element
8 guide element
9 attachment region
10 support region
11 engagement element
12 component base plate
13 screw element

1. A wheel insertion element adapted for moving a component base plate, the wheel insertion element comprising
a frame body,
at least one wheel rotatably mounted on the frame body,
wherein the frame body comprises an upper part and a lower part,
wherein at least one stop element is arranged between the upper part and the lower part,
wherein the frame body is adapted to receive a component base plate in that the component base plate can be inserted along an insertion direction between the upper part and the lower part and can be placed against the at least one stop element, and
wherein a guide element is attached to the upper part and/or to the lower part, which protrudes from the frame body against the insertion direction and is adapted to guide the component base plate into the frame body.

2. The wheel insertion element according to claim 1, characterized in that the stop elements comprise column-shaped stop elements and at least one wall-shaped stop element, which each extend between the upper part and the lower part.

3. The wheel insertion element according to claim 2, characterized in that the column-shaped stop elements are sleeve-shaped and surround a screw element, which is attached for screwing the upper part and the lower part, wherein the column-shaped stop elements are in particular formed as spacers between the upper part and the lower part.

4. The wheel insertion element according to claim 2, characterized in that the at least one wall-shaped stop element is attached to the upper part and/or the lower part, in particular is attached by material bonding, preferably glued.

5. The wheel insertion element according to claim 1, characterized in that two guide elements are attached to each of the upper part and the lower part, wherein a guide element attached to the upper part and a guide element attached to the lower part are formed opposite each other in order to guide the component base plate therebetween.

6. The wheel insertion element according to claim 5, characterized in that two wheels are rotatably mounted on the frame body, wherein all guide elements are attached to a region of the frame body between the wheels.

7. The wheel insertion element according to claim 5, characterized in that each wheel is mounted on a region of the frame body between two stop elements, wherein in particular one stop element is arranged between the wheel and the guide elements.

8. The wheel insertion element according to claim 1, characterized in that the guide element comprises an attachment region and a support region along the insertion direction, wherein the guide element abuts the frame body and is attached thereto at the attachment region, and wherein the guide element protrudes from the frame body at the support region.

9. The wheel insertion element according to claim 1, characterized in that the frame body is formed to rest on a ground on the at least one wheel and on at least one guide element attached to the lower part, wherein in particular a contact of the lower part with the ground is avoided.

10. The wheel insertion element according to claim 1, characterized in that the frame body comprises an engagement element, which is formed for holding and/or guiding the wheel insertion element by a user, in particular a foot of the user, and which extends along a direction which, starting from the upper part, comprises a component in the direction of the lower part or, starting from the lower part, comprises a component in the direction of the upper part, wherein the engagement element is formed in particular in one piece with the upper part and/or the lower part.

11. The wheel insertion element according to claim 1, characterized in that the at least one stop element and/or the guide element is made of plastic or a rubber material, in particular hard rubber material.

12. The wheel insertion element according to claim 1, characterized in that the upper part and/or the lower part are made of a metallic material, in particular of steel or of aluminum.
